(19) United States
(12) Patent Application Publication
(10) Pub. No.: US 2006/0130839 A1
(43) Pub. Date: Jun. 22, 2006

(54) Breathing apparatus for hypoxic pre-acclimatization and training

(76) Inventor: Oleg Bassovitch, Moorabbin (AU)

Correspondence Address: GREENLEE WINNER AND SULLIVAN P C, 4875 PEARL EAST CIRCLE, SUITE 200, BOULDER, CO, 80301, US

(21) Appl. No.: 10/534,403

(22) PCT Filed: Dec. 11, 2003
(86) PCT No.: PCT/IB03/05838

§ 371 Date: Dec. 19, 2005

Related U.S. Application Data
(60) Provisional application No. 60/433,350, filed on Dec. 12, 2002.

(51) Int. Cl. A62B 7/10; A62B 23/02

(52) U.S. Cl. 128/205.28; 128/914; 128/206.15

(57) ABSTRACT

A hand-held rebreather/breathing apparatus for high altitude pre-acclimatization and training. Air exhaled by a user is directed to a reservoir bag for cooling and condensate collection. At inhalation negative pressure created a mixing chamber forces the air stored in the reservoir bag to pass via CO2 absorption chamber where it may be mixed with a fresh portion of the ambient air that influxes via orifice(s) communicating with this chamber. Baseline of the minimum oxygen concentration in inspired air can be pre-set by means of adjustment of the maximum volume of the reservoir bag and/or by means of altering of the number or diameter of one or a plurality of orifices for commination of the ambient air. Biofeedback may be provided by an oxygen monitor.

### FIELD OF THE INVENTION

The disclosed device relates to a breathing apparatus. More particularly the disclosed device relates to devices where users may pre-acclimate to natural conditions met at high altitude and reduced partial pressure oxygen air. The device can be used for preparation of people prior to and during travel to high altitude locations for preparation therefor and can also be used for enhancement of athletic performance and treatment of various chronic medical conditions of the respiratory system.

### BACKGROUND OF THE INVENTION

Pre-acclimatization to high altitude environment at sea level has been shown to produce a cluster of beneficial alterations to mammalian physiology. Short-term respiration by humans with reduced oxygen air initiates a number of compensatory mechanisms and evident at all levels in the body. A course of repeated short-term hypoxia exposures has been demonstrated to stimulate EPO and hemoglobin production and provided stimulation to the respiratory muscles and ventilation. Additionally such a course of short-term hypoxia causes hypotensive and vasodilative effects, reduces free radical formation in the body and also increases the body's antioxidant enzymatic capacity. These physiological responses can be successfully used both for training general and elite athletes as well as for enhancement of general health and well being of humans and animals exposed to such a course of treatment over time.

There are previously known devices (rebreathers) which have been used for pre-acclimatization to high altitude condition (hypoxic training) in the following disclosed patents: U.S. Pat. Nos. 4,086,923; 4,210,137; 4,334,533. Patents USSR: SU1335294; SU1526699; SU1599026; SU1602543; SU1607817; SU1674858; SU1826918; Patents of Russia: RU2021825; RU2040279; RU2070064; RU2067005. Patent of Czechoslovakia 250808.

There are several principal negative issues are inherent to design of currently available rebreathers with chemical absorption of the carbon dioxide. First, conventional chemicals used for carbon dioxide absorption (typically soda lime) produce a chemical reaction during the process thereby resulting in release of heat and water from the user exhaled moist and CO₂ enriched air. Further communicating the breathing air through a compartment with CO₂ absorption chemical such as soda lime creates resistance to breathing by the user who essentially functions as the pump for the process by inhaling and exhaling from their lungs. Additionally, water created in the process of breathing and chemical absorption of the CO₂ from communicated air mixes then with soda lime and tends to melt the absorbent materials together which further increases resistance to breathing.

The devices in the above disclosed patents each have one or more unsolved technical issues such as those listed above, i.e. the devices are not designed to capture condensate and moisture, or have poor cooling of the breathing air that makes it impractical for human use (temperature of breathing air rises above 50 degrees Celsius), or the device has high resistance to breathing that also may be impractical in use thereby impeding user respiration and results in hyperventilation, or the device has insufficient amount/volume of absorption material, inefficient means control and adjust the simulated altitude, or absence of the biological feedback on the progress of hypoxic training, or combinations of one or more of these problems inherent to their design.

One major disadvantage of these devices is that the expired air from the user is immediately directed to a CO₂ absorption chamber and all the moisture contained in the exhaled air (as the part of the human oxygen metabolism process) mixes with the absorption material. This mixing tends to melt or dissolve the particles forming the CO₂ absorbent material and over time severely impedes its ability to absorb CO₂ and easily pass exhaled air through the material itself since passages through the material are continually blocked by the melting process of the material and adherence to adjacent particles. Further, as the air reacts with the absorption material hot and moist breathing air leaves the CO₂ absorption chamber, it cools down and creates condensate droplets that tend to unrestrictedly travel back to the CO₂ absorption chamber and mix with the absorption material, reducing its life span and ability to absorb the CO₂ and further increasing pneumatic resistance to breathing which hampers respiration and results in hyperventilation.

Another disadvantage of known rebreathers is limited or inefficient method of adjustment of the baseline of oxygen concentration and simulated altitude. Additionally, known rebreathers fail to show the user the oxygen concentration in respired air during use.

These problems are overcome by the present invention, which provides respiration with decreased oxygen air with low pneumatic resistance for the patient, means for adjustment of oxygen concentration in inspired air, means for sealed engagement with the face of a user comprising a breathing mask or mouthpiece with directional valves, a heat and moisture exchanger, a transportable case with carbon dioxide absorption chamber, an orifice for influx of atmospheric air, a means for expired air to be directed to the heat and moisture exchanger, a reduction in the volume of respired air determined by body oxygen consumption which is compensated by means of sucking-in a portion of atmospheric air during the inspiratory phase, and means to adjust oxygen concentration in respired air adjusted by variation of diameter of influx orifice and/or selection of volume of expiratory chamber.

An object of the invention is to provide a hypoxicator device with decreased oxygen flow in the airflow along with a low pneumatic resistance for the patient using it.

Another object of this invention is the provision of a personal hypoxicator which has a means of adjustment of oxygen concentration in the inspired air.

A further object of this invention is the provision of such a hypoxicator which includes a heat and moisture exchanger and carbon dioxide absorption chamber which minimizes heating of the air and moisture absorption by the filters.

An additional object of this invention is the provision of a hypoxicator device which is small in size rendering it easily transportable.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive specification in which there are illustrated preferred embodiments of the invention.

Further objects of the invention will be brought out in the following part of the specification, wherein detailed description is for the purpose of fully disclosing the invention without placing limitations thereon. There has thus been outlined, rather broadly the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

To assist with understanding the invention, reference will now be made to the accompanying drawings, which show one example of the invention.

FIG. 1 shows a perspective view of a preferred embodiment of the portable hypoxicator device for altitude stimulation, according to this invention showing an exploded cut away view of the components. The translatable casing is expanded to expand the reservoir cage inside.

FIG. 2 is a side cutaway view of the channels for intake and exhaust of air from the device.

FIG. 3 is a perspective view of the demand valve shown in FIGS. 1 and 4.

FIG. 4 is a side cut away view of the device with arrows depicting airflow therethrough during use. In this view, the casing is translated in on itself to reduce the size of the reservoir cage.

### DETAILED DESCRIPTION OF THE PREFERRED EMBODIMENTS OF THE DISCLOSED DEVICE

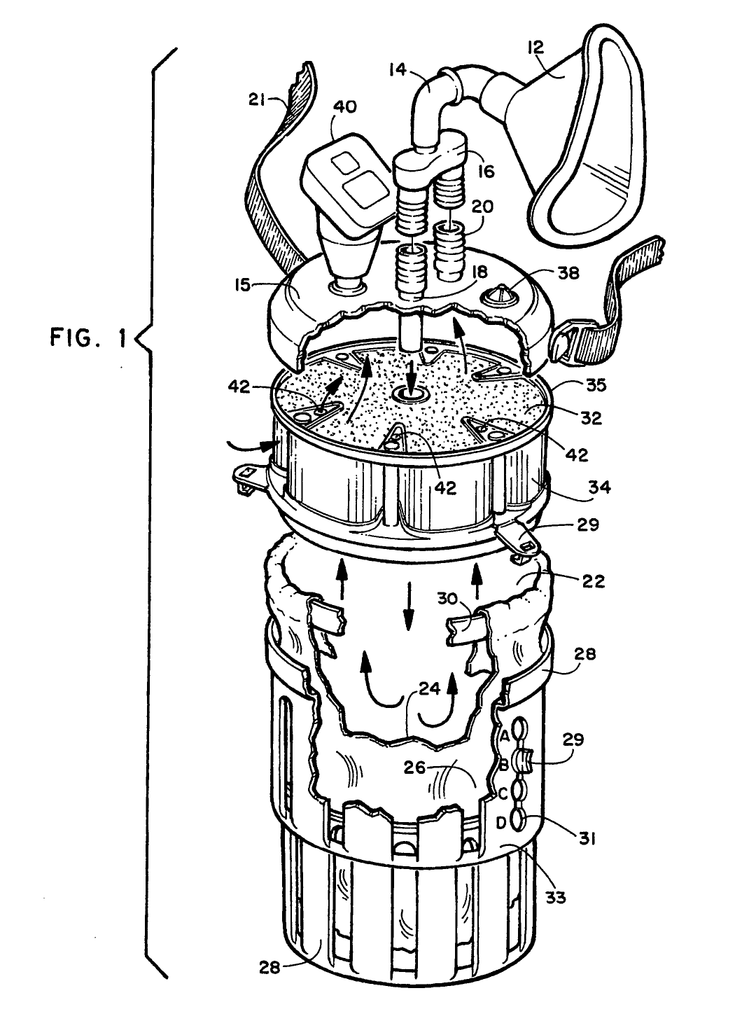

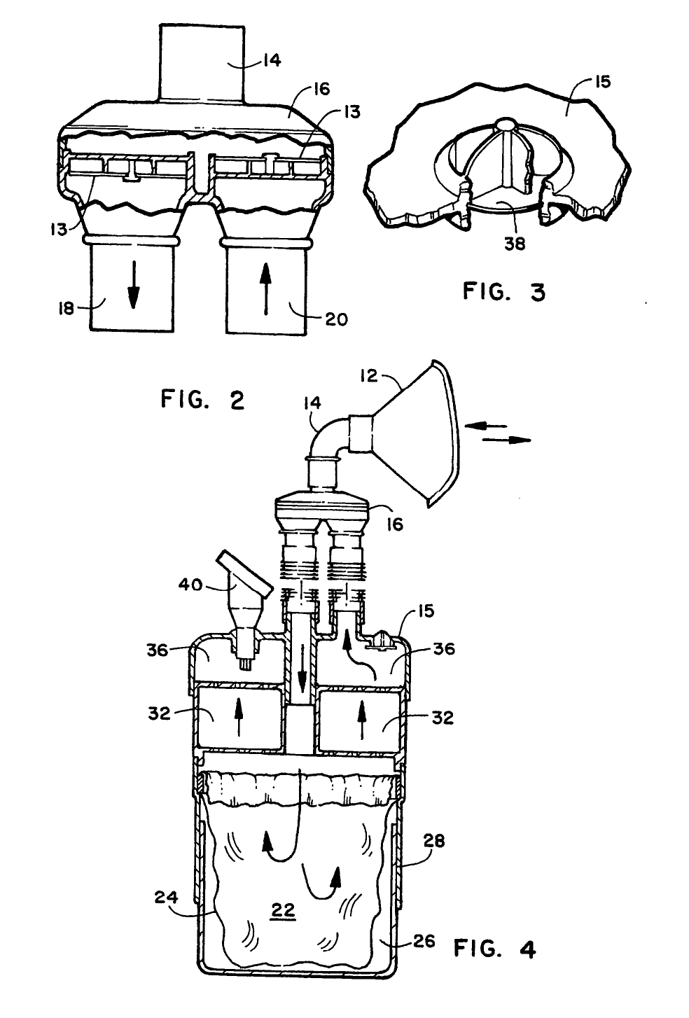

Referring to FIGS. 1-4 the disclosed hypoxicator device 10 is of small stature and easily hand held by a user. It features a means for sealed communication with the respiratory system of the user which is shown in a current preferred mode as a full-face mask 12 adapted to engage over the nose and mouth of a user at an open end and in sealed communication with a conduit 14 which in turn is in sealed engagement with a fitting 16. The fitting 16 provides a mount for, allows communication through a pair of one way valves 13 with an intake conduit 18 and an exhaust conduit 20 both of which are in sealed engagement with the device 10. The fitting 16 and one way valves 13 thus form a non-rebreathing valve using the one way valves 13 insure a one way passage of air through the conduits during inhalation and exhaling by the user into the face mask 12.

In use, air expired by the user into the face mask 12 is communicated through the intake conduit 18 and through the top wall 15 defining the mixing chamber 36 and down the middle of the device and into a variably sized flexible reservoir 22 formed by membrane 24 which expands to hold a determined volume of expired air exhaled by the user inside the reservoir cage 26. The volume of the reservoir cage 26, and the resulting volume of the flexible reservoir 22 formed inside the plastic or other flexible membrane 24, is determined by the volume inside the telescoping sidewalls of the casing 28 forming the reservoir cage 26. The largest volume of the reservoir cage 26 occurs with the sidewalls translated outward increasing the area for expansion of the membrane 24 and the flexible reservoir 22. The smaller volume of the reservoir cage 26 is achieved by collaps g the walls forming the casing 28 which reduces the size of the reservoir cage 26 and thus the flexible reservoir 22 as best shown in FIG. 4. The walls forming the telescopic casing 28 can translate between a collapsed position wherein the size of the reservoir cage 26 would be at its smallest volume to an extended position wherein the size of the reservoir cage 26 would be at its largest in volume. Using means for selection of the volume of the reservoir cage 26, which in this case would be a depressable button 29 engageable with any one of a plurality of slots 31, the user may easily vary the size of the reservoir cage 26 and the resulting size of the flexible reservoir 22 formed inside by the membrane 24. Indicia 33, adjacent to the slots 31, provides the user a means to determine the desired size of the resulting flexible reservoir 22 for the task by engaging the button 29 in the appropriate slot 31 marked by the indica 33. A sealing ring 30 holds the membrane 24 which in the current preferred mode is a flexible bag, in engagement with one of the walls forming the casing 28 which as shown in FIG. 1 is adapted to cooperatively engage with the membrane 24 and sealing ring 30.

Negative pressure produced by lungs of the user in sealed engagement with the face mack 12 during an inspiratory phase produces a negative pressure in the flexible reservoir 22 situated inside reservoir cage 26 which as noted above, may be varied in size. Air stored in the heat/moisture exchanger chamber passes through the carbon dioxide absorption chamber 32 or “CO₂ scrubbing chamber.”

While passing through the absorption chamber 32, the excess of carbon dioxide is removed from the breathing air by means of chemical absorption using a chemical means for removal of carbon dioxide from the air inside of a cartridge 34 containing soda lime or similar carbon dioxide absorbing material. The absorbent material is held in the absorption chamber 32 which is inside the interior of the sidewall 35 forming the cartridge 34 and the sidewall 35 is fitted to a sealed engagement with the flexible reservoir 22 on one side and the mixing chamber 36 on the other side to form an absorption chamber 32 through which air passes from the inside of the flexible reservoir 22 to the mixing chamber 36 formed by the top wall 15, and then to the lungs of the user.

The cartridge 34 is held to the casing 28 with tabs 29 or other means for holding the cartridge in sealed engagement with the flexible reservoir 22 held inside the casing 28. The top wall 15 forming the mixing chamber 36 engages with the top side edge of the sidewall 34 of the cartridge 34 by frictional engagement or by mechanical attachment of the top wall 15 to the top of the cartridge 34 in a sealed engagement. The device 10 is thus of modular construction and the unique use of a [symbol] engages with the other modular components forming the device 10 allows for easy removal and replacement of the cartridge 34 from the top wall 15 and the casing 28. With equal ease, the membrane 24 is easily replaced once the cartridge 34 is removed, by simply pulling the sealing ring 30 from the casing 28 and installing a new bag forming the membrane 24 defining the flexible reservoir 22 in reverse fashion.

During re-breathing by the user engaged with the face mask 12, the oxygen concentration gradually decreases due to body oxygen consumption as well as the volume of breathing air in the system. If required for longer use, a means to communicate metered amounts of exterior air to the mixing chamber may be provided to replenish oxygen to the inhaled air in a measured fashion to the system. In one preferred embodiment a means to communicate metered amounts of air to the mixing chamber is provided by small orifices 42 communicating outside air into the mixing chamber 36 either through indents in the cartridge 34 or they could be in the top wall 15. These orifices 42 are sized to communicate small amounts of outside air to the mixing chamber 36. The size and number of these orifices 42 may be changed to introduce more or less air into the system during use, depending on the user, the type of use, and the training for which the device 10 is being used. For more air introduction into the system the number and/or size fo the orifices 42 would may be changed. For less or nor air introduction into the system, they might be left off entirely. In case of a deep breath-in made by the user, the volume of air stored in the device 10 and provided though the small orifices 42 can be insufficient, especially when the casing 28 is in a collapsed position minimizing the size of the flexible reservoir 22. Should this occur, an influx of atmospheric air then may take place via a one way demand valve 28 which communicates with the mixing chamber 36 and allows for the ingress of outside air if needed. The demand valve 38 however would stay closed in all other times. Optionally, one or a second demand valve 38 could be placed through the top wall 15 which would open slightly on a determined amount of negative pressure provided by the user inhaling. The demand valve 38 thus could be used in place of the orifices 42 providing air replenishment. Finally, a single demand valve 38 might be engineered to provide both air replenishment to the mixing chamber and an immediate release if air volume in the flexible reservoir 22 is too small for the size of the user's inhalation.

By translating the two sliding walls forming the casing 28 in relation to each other, the maximum volume of the flexible reservoir 22 formed inside the casing 28 may be varied thereby increasing or decreasing of the volume of the breathing reservoir available to the user. This change in volume is of course adjustable by the user depending on the lung volume, height, weight, age, and metabolic rate of the particular user to achieve a desired personal setting for the individual user for the purpose intended. The period of time to complete collapse of the membrane 24 and the flexible reservoir 22 formed inside can be delayed or reduced and therefore the minimum oxygen concentration can reach lower values in case of larger maximum volume breathing bag and vice versa Changing the size of the reservoir cage 26 by telescoping the two sidewalls making up the casing 28 and thus the maximum size of the flexible reservoir 22 inside the membrane 24 will determine the baseline of oxygen concentration in respired air for the user. These adjustments in the size of the flexible reservoir 22, and the amount of oxygen introduced into the system, if any, through the orifices 42 or the valve 38 allows the user great adjustment to the individual use of the device 10 depending on their training protocol and individual requirements.

In an alternate preferred embodiment of the device 10, a means to monitor oxygen levels communicated to the lungs of the user is provided in the form of an oxygen monitor 40 may be installed in a sealed engagement through the top wall 15 such that it can monitor the oxygen concentration in the mixing chamber 36 in real time. This gives the user real time information about the oxygen concentration of the air they are breathing in from the mixing chamber 36.

During a normal session, once the Hypoxicator device 10 has been assembled (and calibrated, if you have used the optional oxygen monitor 40) the user can proceed with a hypoxic training session.

The duration of a session should typically be about one hour. This consists of five minutes of breathing Hypoxic air with the user's face in sealed engagement with the face mask 12 followed by five minutes of breathing ambient air with the face mask 12 disengaged. A typical session therefore consists of six cycles. This is a standard approach recommended by IHT practitioners.

Simulated altitude adjustment on an individual basis by the user may be achieved by adjusting the size of the telescopic casing 28 to simulate the altitude at which the user wishes to train. This is done by reading the indicia 33 adjacent to the slots 31 and then pressing in the two buttons 29 located on either side of the casing 28 and moving the sidewall up or down. The button 29 is attached to the interior sidewall and engages the exterior sidewall of the casing 28 through the appropriate slot 31. Once the button 29 is engaged through the slot 31 bearing the indicia 33 indicating the appropriate altitude, it pops out and engages the slot 31 thereby holding the casing 28 at the size intended. As noted, allowing air into the system or not, through the orifices 42 or valve 38 noted above may also be adjusted in addition to varying the size of the flexible reservoir, to provide individual training and altitude adjustment for each individual user.

A plurality of slots 31 is provided with indicia 33 indicating an approximate simulated altitude achieved by altering the volume of the flexible reservoir 22. As the volume of the flexible reservoir 22 increases, so does the simulated altitude. As depicted in FIG. 1, there are four altitude levels in a current favored mode designated by the four slots 31. The lowest altitude setting corresponds to approximately 2,500 m. The second notch corresponds to approximately 3500 m. The third to 4500 m and with the casing 28 in the fully extended position, an altitude of approximately 5500 m will be simulated to the user. To more accurately determine the simulated altitude during use, the optional Oxygen monitor 40 to monitor oxygen levels in the mixing chamber 36 may be used.

To use the device 10 once assembled, the user places the neck strap 21 of the device 10 over their head and adjusts the strap 21 comfortably on the back their neck. Then, a timing means, such as a timer, a clock, or in a current preferred mode an hourglass, is started to give the user a visual of the elapsed time. Once the timer is started, the user breathes normally with their face engaged with the mask 12 so that all the air entering and leaving their lungs, flows through the device 10.

At the end of a first five minute period breathing through the device, 10 the user takes off the mask 12 and breathes normal air for five minutes. Once they have breathed normal air for five minutes, they start the timer again with the mask 12 engaged over their mouth for another five minute session with the mask 12 engaged. This routine of five minutes on, five minutes off, would continue over the course of the training session. Once the training session is finished, the user would take the device off.

Subsequent sessions may be used to acclimate the user to ever higher elevations by adjusting the size of the casing 28 using the buttons 29 engaged in different appropriate slots 31. The device 10 thus allows users to acclimate for altitude before they ever reach it. Also, athletes can use the device to help their bodies function better with less oxygen.

The device shown in the drawings and described in detail herein disclose arrangements of elements of particular construction and configuration for illustrating preferred embodiments of structure and method of operation of the present invention. It is to be understood, however, that elements of different construction and configuration and other arrangements thereof, other than those illustrated and described, may be employed in accordance with the spirit of this invention, and such changes, alternations and modifications as would occur to those skilled in the art are considered to be within the scope of this invention as broadly defined in the appended claims.

As such, while the present invention has been described herein with reference to particular embodiments thereof, a latitude of modifications, various changes and substitutions are intended in the foregoing disclosure, and will be appreciated that in some instance some features of the invention will be employed without a corresponding use of other features without departing from the scope of the invention as set forth in the following claims.

What is claimed is:

1. An apparatus for breathing an air mixture expired by a user, providing an air mixture which has lower oxygen concentration than the ambient air, said apparatus comprising:
an expiratory path, said expiratory path communicating with a reservoir, said reservoir being of adjustably variable volume;
an inspiratory path communicating with said reservoir through a CO₂ absorption chamber; and
a directional valve, said directional valve allowing single direction flow of air through both said expiratory path and said inspiratory path; and
means of communication of said expiratory path and said inspiratory path in sealed engagement with the respiratory system of a user.

2. The apparatus of claim 1 wherein said reservoir additionally comprises:
means to vary the volume of the said reservoir from a minimum volume area to a maximum volume area.

3. The apparatus of claim 2 wherein said means to vary the volume of said reservoir comprises:
said reservoir formed by a flexible membrane;
said flexible membrane housed in a chamber, said chamber formed inside a reservoir case having a sidewall, an endwall and an aperture end opposite said endwall; and
means to vary the volume of said chamber thereby limiting the expansion of said flexible membrane forming said reservoir.

4. The apparatus of claim 3 wherein said means to vary the volume of said chamber comprises:
said reservoir case formed of a telescopic sidewall terminating at said endwall on one end and said aperture end, said sidewall extendable from a first position wherein said chamber is of minimum volume to an extended position wherein said chamber is of maximum volume.

5. The apparatus of claim 4 wherein said means to vary the volume of said chamber additionally comprises:
said sidewall extendable to at least one additional different position between said first position and said extended position; and
means to hold said sidewall in said at least one additional different position thereby allowing user adjustment of the total volume of said chamber and concurrently total volume of said reservoir.

6. The apparatus of claim 1 additi [symbol]
means for mixing inspired air communicated to said user from said inspiratory path with ambient air, thereby adjusting oxygen content of said inspired air.

7. The apparatus of claim 2 additionally comprising:
means for mixing inspired air communicated to said user from said inspiratory path with ambient air, thereby adjusting oxygen content of said inspired air.

8. The apparatus of claim 3 additionally comprising:
means for mixing inspired air communicated to said user from said inspiratory path with >ambient air, thereby adjusting oxygen content of said inspired air.

9. The apparatus of claim 6 additionally comprising:
said means for mixing inspired air communicated to said user being adjustable thereby allowing more or less ambient air to communicate with said inspiratory path to provide means to adjust oxygen levels of said inspired air.

10. The apparatus of claim 7 additionally comprising:
said means for mixing inspired air communicated to said user being adjustable thereby allowing more or less ambient air to communicate with said inspiratory path to provide means to adjust oxygen levels of said inspired air.

11. The apparatus of claim 8 additionally comprising:
said means for mixing inspired air communicated to said user being adjustable thereby allowing more or less ambient air to communicate with said inspiratory path to provide means to adjust oxygen levels of said inspired air.

12. The apparatus of claim 3 additionally comprising:
apertures communicating through said sidewall with between said chamber and ambient air adjacent to said sidewall;
said reservoir membrane comprised of flexible thermo-conductive material that effectively equalizes the temperature of the expired air in said reservoir with communicating ambient air, thereby providing a means to decreases dew point of the said expired air in order to reduce humidity thereof and a means to decrease temperature of said expired air.

13. The apparatus of claim 4 additionally comprising:
apertures communicating through said sidewall with between said chamber and ambient air adjacent to said sidewall;
said reservoir membrane comprised of flexible thermo-conductive material that effectively equalizes the temperature of the expired air in said reservoir with communicating ambient air, thereby providing a means to decreases dew point of the said expired air in order to reduce humidity thereof and a means to decrease temperature of said expired air.

14. The apparatus of claim 11 additionally comprising:
apertures communicating through said sidewall with between said chamber and ambient air adjacent to said sidewall;
said reservoir membrane comprised of flexible thermo-conductive material that effectively equalizes the temperature of the expired air in said reservoir with communicating ambient air, thereby providing a means to decreases dew point of the said expired air in order to reduce humidity thereof and a means to decrease temperature of said expired air.

15. The apparatus of claim 6 wherein said means for mixing inspired air communicated to said user from said inspiratory path with ambient air comprises one or a combination of: at least one passage communicating between said inspiratory path and ambient air and a demand valve, said demand valve opening when the volume of the said breathing reservoir is fully depleted thereby allowing replenishment of the breathing volume for the user.

16. The apparatus of claim 9 wherein said means for mixing inspired air communicated to said user from said inspiratory path with ambient air comprises one or a combination of: at least one passage communicating between said inspiratory path and ambient air and a demand valve, said demand valve opening when the volume of the said breathing reservoir is fully depleted thereby allowing replenishment of the breathing volume for the user.

17. The apparatus of claim 1 additionally comprising:
said reservoir positioned below said CO₂ absorption chamber and providing a means for collection of moister in air expired by said user and holding said moisture in said reservoir with gravity thereby substantially preventing said moisture from communication with said CO₂ absorption chamber.

18. The apparatus of claim 12 additionally comprising:
said reservoir positioned below said CO₂ absorption chamber and providing a means for collection of moister in air expired by said user and holding said moisture in said reservoir with gravity thereby substantially preventing said moisture from communication with said CO, absorption chamber.

19. The apparatus of claim 1 wherein said breathing reservoir is disposable and may be removed and replaced when a training session is finished.

20. The apparatus of claim 3 wherein said breathing reservoir is disposable and may be removed and replaced when a training session is finished.

21. The apparatus of claim 1 wherein said inspiratory path is equipped with a port for communication of an oxygen analyzer with air in said inspiratory path, said oxygen analyzer capable of display of indicia showing the oxygen concentration in the inspired air mixture.

22. The apparatus of claim 3 wherein said CO₂ absorption chamber is a canister;
said canister having a chemical means for a CO₂ absorption located therein; and
means for attachment of said cannister to said case to said aperture end of said reservoir case with said chemical means in communication with said reservoir, whereby said cannister is replaceable.
